(19) United States
(12) Patent Application Publication
(10) Pub. No.: US 2014/0061079 A1
(43) Pub. Date: Mar. 6, 2014

(54) Touch screen barrier system

(71) Applicant: Alexander N. McCrae, Royal Palm Beach, FL (US)

(72) Inventor: Alexander N. McCrae, Royal Palm Beach, FL (US)

(21) Appl. No.: 13/815,306

(22) Filed: Feb. 19, 2013

Related U.S. Application Data
(60) Provisional application No. 61/599,576, filed on Feb. 16, 2012.

(51) Int. Cl. C09J 7/04

(52) U.S. Cl. CPC C09J 7/04
USPC 206/449; 428/40.5

(57) ABSTRACT

A touch screen barrier system having a multiple layer touch screen barrier and dispenser. The touch screen barrier adheres to a user's forger or thumb to provide a barrier to the touch screen or other public device, such as elevator buttons, to prevent the transfer of oils, germs or other debris that cause smudges on the screen during use or transfer germs. The dispenser holds and provides access to a plurality of touch screen barriers and is compact for transporting in the user's pocket.

### CROSS REFERENCE TO RELATED APPLICATIONS

This application claims the benefit of provisional patent application Ser. No. 61/599,576 filed Feb. 16, 2012.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

This invention relates generally to a touch screen barrier system, and more particularly, to touch screen barrier system having a patch that is adhered to a finger or thumb for providing a barrier between the finger or thumb and touch screen of a cell phone, iPad®, computer screen or other touch screen device to keep the screen of such devices clean from smudges, oils, food and other debris that may collect on one's fingers and to protect against the transfer of germs. The system also includes a dispenser for storing and accessing the touch screen barriers.

2. Description of the Background Art

It is well known that touch screens on cell phones, iPads®, computer screens and other communication devices accumulate smudges from oils, food and other debris on the user's fingers. These smudges can make it difficult to see the screen or use the device and also make the device appear unsightly, which can be embarrassing. In addition, there is a problem with the transfer of germs when using touch screens and even elevator buttons and other commonly touched devices. A further issue is the ability of others to use smudge patterns to unlock and breach cell phones. Currently, the only known device and method to avoid smudges and germs on a touch screen is to regularly clean the screen with a solution and wipe. There is also no known device that provides a barrier for touching cell phone screens, elevator buttons and other publicly used devices.

There are a variety of devices for cleaning screens and preventing smudges. For instance, U.S. Pat. No. 3,638,789, issued Feb. 1, 1972 to Tuszewski, discloses a disposable finger protecting cleansing mitt. U.S. Pat. No. 4,670,930, issued Jun. 9, 1987 to Lu, discloses cleaning gloves. U.S. Pat. No. 4,959,881, issued Oct. 2, 1990 to Murray, discloses a cleaning mitt. U.S. Pat. No. 5,248,211, issued Sep. 28, 1993 to Hoist discloses a windshield cleaner. U.S. Pat. No. 7,546,657, issued Jun. 16, 2009 to Gurley, discloses a cleaning tool for mobile electronic devices. U.S. Pat. No. 7,849,521, issued Dec. 14, 2010 to Cromwell, discloses a fingertip manipulation device for use with gloves and insertion devices and method of insertion. U.S. Pat. No. 8,044,942, dated Oct. 25, 2011 to Leonhard et al., discloses a touch screen protector. U.S. Patent Publication No. 2009/0078478 dated Mar. 26, 2009 to Newman discloses a finger tip stylus. U.S. Patent Publication No. 2009/0235478 dated Sep. 24, 2009 to England discloses a lens and display cleaning device and method of use. U.S. Patent Publication No. 2009/0278818 dated Nov. 12, 2009 to DiNozzi et al. discloses a thumb worn tap device and storage holders for use with handheld electronics. The foregoing references fail to disclose a touch screen barrier system having a patch adhered to a finger or thumb for providing a barrier between the finger or thumb and touch screen of a cell phone, iPad® or computer screen.

If a device existed that could prevent the smudges from ever occurring, it would obviate these problems and be well received. Unfortunately, there are no known devices that can prevent or provide a barrier to these smudges. It is, therefore, to the effective resolution of the aforementioned problems and shortcomings of the prior art that the present invention is directed. The instant invention addresses this unfulfilled need in the prior art by providing a touch screen barrier device and dispenser as contemplated by the instant invention disclosed herein.

### BRIEF SUMMARY OF THE INVENTION

In light of the foregoing, it is an object of the present invention to provide a touch screen barrier that prevents smudges on touch screen devices, such as cell phones and computers.

It is also an object of the instant invention to provide a touch screen barrier system that may be packaged with multiple screens.

It is an additional object of the instant invention to provide a touch screen barrier system that is easy to use.

It is a further object of the instant invention to provide a touch screen barrier system that is same color as skin.

It is another object of the instant invention to provide a touch screen barrier system having a dispenser.

In light of these and other objects, the instant invention comprises a touch screen barrier system having a multiple layer touch screen barrier and a dispenser. The touch screen barrier of the instant invention adheres to a user's finger or thumb to provide a barrier to the touch screen or other public device, such as elevator buttons, to prevent the transfer of oils, germs or other debris that cause smudges on the screen during use or transfer germs. The dispenser holds and provides access to a plurality of touch screen barriers and is compact for transporting in the user's pocket.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is an elevational view of the touch screen barrier system in accordance with the preferred embodiment of the instant invention.

FIG. 2 is a side elevational view of the touch screen barrier system in accordance with the preferred embodiment of the instant invention.

FIG. 3 is a perspective view of the dispenser and barriers showing the dispenser closed in accordance with the preferred embodiment of the instant invention.

FIG. 4 is a perspective view of the dispenser and barriers showing the dispenser opened in accordance with the preferred embodiment of the instant invention.

FIG. 5 is an elevational view of an alternative embodiment of the instant invention.

FIG. 6 is a perspective view of an alternative embodiment of the instant invention.

### DETAILED DESCRIPTION OF THE INVENTION

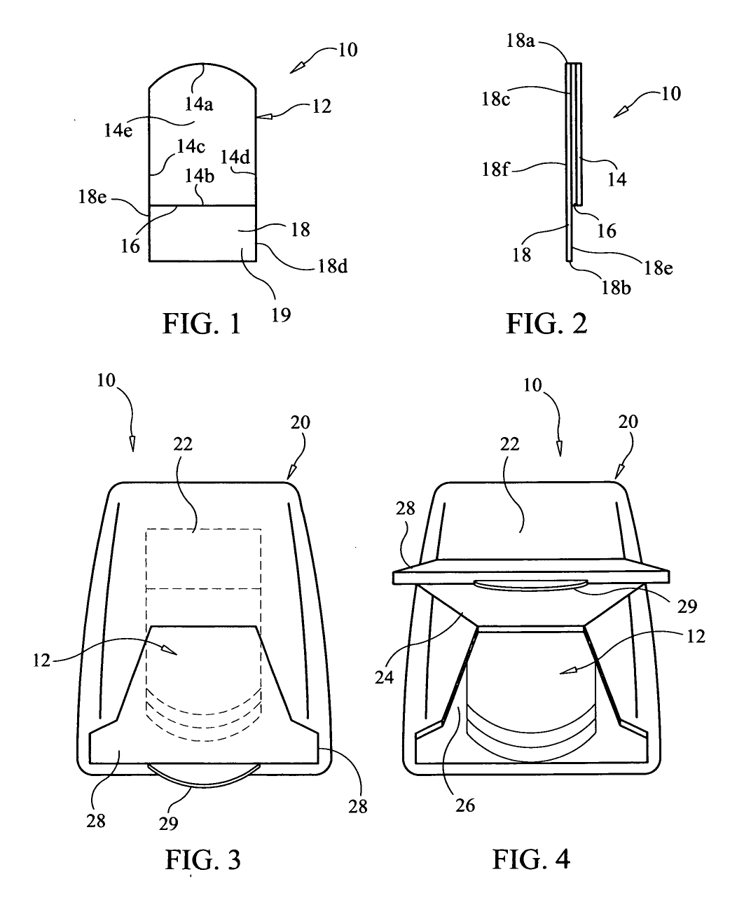

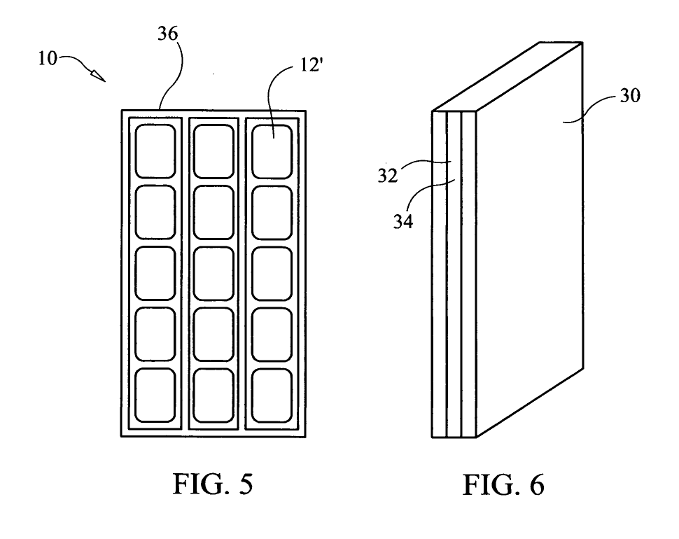

With reference to the drawings, FIGS. 1 to 6 depict the preferred embodiment of the instant invention which is generally referenced as a touch screen barrier system and, or by numeric character 10. The touch screen barrier system 10 comprises a multiple layer touch screen barrier 12 and a dispenser. The touch screen barrier 12 of the instant invention adheres to a user's finger or thumb to provide a barrier to the touch screen or other public device, such as elevator buttons, to prevent the transfer of oils, germs or other debris that cause smudges on the screen during use or transfer germs. The dispenser 20 holds and provides access to a plurality of touch screen barriers 12 and is compact for transporting in the user's pocket.

With reference to FIGS. 1-6, the touch screen barrier 12 comprises a textile layer 14, an adhesive layer 16 and a wax paper layer 18. The textile layer 14 releasably adheres to the wax paper layer 18 by virtue of the adhesive layer 16 for convenient storage and access. The textile layer 14 defines an upper arched end 14a to correspond to the arcuate shape of a user's finger tip, a lower end 12b, side edges 14c, 14d, a front surface 14e and a rear surface 14f. The overall shape may be oval. The front surface 14e is used for touching an electronic device's screen or other public surface while the rear surface 14f releasably adheres to a user's finger or thumb. The textile layer 14 preferably comprises a semi-elastic or elastic skin colored fabric, but may comprise other colors to appeal to a user's preference for colors. The textile layer 14 may comprise a woven nylon or polymer fibers embedded into cloth. The adhesive layer 16 is applied to the rear surface of the textile layer 14 and thus assumes the shape of the textile layer 14. The adhesive layer 16 preferably comprises a hypoallergenic hot melt adhesive. The adhesive layer 16 may alternatively comprise the adhesives used on adhesive bandages, such as Band Aid®, or on Post-its® or a skin-safe epoxy. The wax paper layer 18 comprises an upper arched end 18a, a lower flat end 18b, flat side edges 18c,18d, a front surface 18e and a rear surface 18f. The wax paper upper arched end 18a complements and corresponds to the curvature of the upper arched end 14a of the textile layer 14. It should be noted that the textile layer lower end 14b and wax paper lower end 18b may be arched instead of flat. When joined, the adhesive layer 16 releasably adheres to the front surface 18e of the wax paper layer 18. The wax paper layer 18 is longer than the textile layer 14 such that the lower flat end 18b extends below the lower flat end 14b of the fabric layer 14 when the fabric layer 14 is aligned with and adhered to the wax paper layer 18. The extended portion of the wax paper 18 provides a convenient tab 19 for pulling the touch screen barrier 12 from the dispenser and removing the fabric layer 14 from the wax paper 18 for use. The touch screen barrier 12 is approximately 1.5 inches long and 0.75 inches wide. These dimensions may vary without departing from the scope and spirit of the instant invention 10.

With reference to FIGS. 1-6, the dispenser 20 comprises a container body 22 defining an inner volume 24, access opening 26 and hinged door 28 to conceal and reveal the access opening 26. The dispenser 20 has a compact design for convenient transport in a user's pocket. A plurality of touch screen barriers 12 are stacked and stored in the inner volume 24 of the dispenser 20 until one is needed. The access door 28 is kept closed to conceal and protect the touch screen barriers 12. The access door 28 is opened to access and pull out barriers 12 through the access opening 26. The access door 28 is opened and closed by pulling the tab 29 up and down, respectively. The access door 28 snaps shut to the body 22 when pulled completely down. The barriers 12 are stacked with the rear surface 18f sitting on and engaging the front surface 14a of the textile layer 14 and front surface 18e of the extended tab 19 of the wax paper layer 18.

To use the touch screen system 10 of the instant invention, a user merely transports the dispenser 20 with a supply of touch screen barriers 12 in a pocket or travel bag. When the user is about to use a cell phone or other electronic device with a touch screen, they retrieve the dispenser 20, open the dispenser door 28 and pull out the touch screen barrier 12 on the top of the stack through the access opening 26 by pulling on the tab 19. Once a touch screen barrier 12 has been pulled from the dispenser 20, the textile layer 14 must be removed from the wax paper layer 18. This is done by holding and bending the wax paper tab 19 to loosen the flat lower end 14b of the textile layer 14 and peeling the textile layer 14 off the front surface 18e of the wax paper layer 18 by pulling the textile layer lower end 14b upward. Once the textile layer 14 is completely removed from the wax paper layer 18, it is oriented over the tip of the index finger or other desired finger, with the adhesive layer 16 facing toward the finger, and placed and adhered to the finger with the textile arched end 14a closest to the tip of the finger. Once mounted on the finger, the instant invention 10 is ready to use by using the front surface 14e of the textile layer 14 to touch the screen. Once done using the electronic device, the touch screen barrier 12 is removed from the finger and discarded. When another barrier 12 is needed, the same process is repeated.

In an alternative embodiment, the dispenser may comprise a thin box shaped dispenser 30 defining an inner volume 32 and access opening 34 for inserting several touch screen barrier sheets 36. A touch screen barrier sheet 36 comprises wax paper and defines a plurality of rows and columns of alternative touch screen barriers 12′. The alternative touch screen barriers 12′ do not require the wax paper layer 18 as they are stored the wax paper sheet 36. The alternative touch screen barrier 12′ is the same as the preferred touch screen barrier 12 in all other respects. When a touch screen barrier 12′ is needed, a sheet 36 is pulled from the dispenser 30 out the access opening 34. An alternative touch screen barrier 12′ is removed from the wax paper sheet 36 by pulling upward on the lower flat end to remove and then applied to the tip of a finger as described above.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

What is claimed is:

1. A touch screen barrier system, said system comprising:
a textile layer;
an adhesive layer;
a wax paper layer, said wax paper layer releasably adhering to said textile layer by said adhesive layer; and
an upper arched end defined by said textile layer to correspond to the arcuate shape of a finger tip.

2. A system as recited in claim 1, further comprising:
a textile layer having a semi-elastic fabric.

3. A system as recited in claim 2, wherein said textile layer comprises a skin color.

4. A system as recited in claim 2, wherein said textile layer comprises nylon or polymer.

5. A system as recited in claim 1, wherein said wax paper layer comprises an upper arched end, a lower flat end, flat side edges, a front surface and a rear surface.

6. A system as recited in claim 1, further comprising a dispenser for holding and storing said touch screen barrier system.

7. A system as recited in claim 6, wherein said dispenser comprises:
a container body having an inner volume, access opening and hinged door; and
a plurality of touch screen barriers stored in said inner volume.

8. A system as recited in claim 1, wherein said adhesive layer comprises a hypoallergenic hot melt adhesive.

9. A system as recited in claim 1, wherein said adhesive layer comprises a skin-safe epoxy.

10. A system as recited in claim 1, wherein said wax paper layer comprises an upper arched end, a lower flat end, flat side edges, a front surface and a rear surface.

11. A system as recited in claim 1, wherein said wax paper layer is longer than said textile layer.
